(19) United States
(12) Patent Application Publication
(10) Pub. No.: US 2016/0011666 A1
(43) Pub. Date: Jan. 14, 2016

(54) HAPTIC DEVICE

(71) Applicants: TAMPEREEN YLIOPISTO, Tampereen yliopisto (FI); FUKOKU CO., LTD., Ageo-shi (JP)

(72) Inventors: Grigori EVREINOV, Tampere (FI); Ahmed FAROOQ, Tampere (FI); Roope RAISAMO, Tampere (FI); Arto HIPPULA, Tampere (FI); Daisuke TAKAHATA, Saitama (JP)

(21) Appl. No.: 14/794,278

(22) Filed: Jul. 8, 2015

(30) Foreign Application Priority Data
Jul. 9, 2014 (JP) 2014-141264

(51) Int. Cl. G06F 3/01; G06F 3/041

(52) U.S. Cl. CPC G06F 3/016; G06F 3/041

(57) ABSTRACT

One embodiment of the present invention provides a haptic device to be overlaid on a manipulation face for receiving a manipulation from a user. The haptic device includes a pouch, a liquid or gel-like substance and an actuator. The pouch is formed from the manipulation face and a transparent sheet overlaid thereon with a gap. The liquid or gel-like substance is sealed within the pouch and configured to transmit a pressure or/and pressure vibration therethrough. The actuator is configured to generate a haptic signal in the transparent sheet and/or the substance so as to be transmitted to the user.

### CROSS-REFERENCE TO RELATED APPLICATION(S)

This application claims priority from JP Patent Application No. 2014-141264 filed on Jul. 9, 2014, the entire contents of which are incorporated herein by reference.

1. Technical Field

This invention relates generally to a haptic device, and more particularly to, a compliant overlay for interacting with a touch-sensitive surface, screen or the like, and to a method for enhancing a response of a human skin to a vibrational stimulation.

2. Background Art

The mechanical stimulation of the human is the process by which mechanical energy from a source of vibration in a kind of periodic compression and micro displacements impacts on the human body, usually the skin or a body segment. Mechanical energy of a stimulus is converted then by sensory receptors into feelings interpreted as tactile information associated with physical properties of the contact surface. The need for the use of tactile information channel and simulation of the tactile feelings led to development of tactile transducers. However, neglecting the features of mechanical energy propagation from actuator to specific receptors in the skin and their functionality attenuates the magnitude of tactile signals by making tactile signals weak and less informative as expected. At that, one of key factors is mechanical impedance of each component involved into mechanotransduction process through different materials having different physical properties such as density and mechanical impedance, which modulate energy of stimuli. Moreover, investigations into the mechanical impedance of the skin at the finger have shown a nonlinear increase in stiffness when pressure was produced against the contact surface until a maximum skin indentation of approximately 3 mm (e.g., Mortimer, B. J. P. et al., “Vibrotactile transduction and transducers” J. Acoust. Soc. Am., 2007, 121(5), 2970-2977).

The skin is a multi-layer, geometrically and structurally complex mechanical system supported on a deformable system of soft connective tissues such as muscles, vessels and fat. At the fingertip, the skin is composed of three general layers, the epidermis, dermis, and subcutaneous tissues of hypodermis. The base layer of the epidermis is considerably stiffer than the dermis or subcutaneous tissues. The epidermis and dermis are physically fixed to each other with the intermediate ridges. Being configured with both a stiffness differential between the two layers and intermediate ridges, this epidermal-dermal junction creates a filtering mechanism distributing forces and stresses from the contact point to the Merkel cell complexes.

These mechanoreceptors are most sensitive to static deformation and lie at the tips of the intermediate ridges. By introducing papillary and intermediate ridges, upon plate deformation, the normal force, tangent force, and strain energy density were concentrated near the tips of the intermediate ridges (e.g., Maeno T. et al. “Relationship between the structure of human finger tissue and the location of tactile receptors” JSME Int. J., 1998, 41(1, C), 94-100.). The fingertip microstructure's intermediate ridges and epidermal-dermal stiffness difference produce a high, local stress concentration at the ridge tips, where the receptors are located to optimally collect the directed, concentrated stress (e.g., Gerling, G. J. “SA-I mechanoreceptor position in fingertip skin may impact sensitivity to edge stimuli” Applied Bionics and Biomechanics, 2010, 7(1), 19-29, Gerling G. J. et al. “The effect of fingertip microstructures on tactile edge perception” Eurohaptics Conference, and Symposium on Haptic Interfaces for Virtual Environment and Teleoperator Systems, 2005, 63-72).

However, this gentle and sophisticated tactile mechanism becomes useless when fingertip acts against a flat rigid surface of touchscreen, chemically strengthened alkali-aluminosilicate glass. Formally, it is impossible to provide effective and efficient stimulation of skin receptors by transmitting mechanical signals in a wide range of frequencies through display system. Therefore, efforts have to be undertaken to improve the conditions for propagation of mechanical energy of the stimuli to skin receptors and to develop screen overlays as a mediator of tactile signals.

Deformable transparent display overlays initially have been designed to detect the pressure and position of the user fingertip on CRT displays (e.g., U.S. Pat. No. 4,542,375-A, U.S. Pat. No. 4,816,811-A). However, these solutions have not been implemented to improve conditions for mechanical propagation of any kind of signals presented through tactile channel.

There are disclosed transparent keyboard switches (e.g., U.S. Pat. No. 4,017,848-A, U.S. Pat. No. 4,786,767-A) comprising of a relatively rigid transparent substrate and relatively flexible transparent film containing conductive and transparent electrodes separated by an insulating fluid, to enable increased keystroke length and different reaction forces when pressing and releasing the transparent switch structure. The transparent switch mechanism was improved to provide enhanced tactile feel of the reaction forces (e.g., JP-2005-234704-A, Weissman, A. W. “Modeling of Micro-scale Touch Sensations for use with Haptically Augmented Reality” MSc. Thesis, Rochester Inst. of Technology, Rochester, N.Y., USA, 2010). However, these embodiments improve the conditions for mechanical propagation of a limited range of tactile signals accompanying the toggling of the switches or buttons having a specific design.

Another way of improving the response of the human skin is in enhancing the sensitivity of tactile receptors. The sensory parameters of touch may be improved, in particular, to lower the threshold of skin receptors (e.g., U.S. Pat. No. 5,782,873-A, U.S. Pat. No. 6,032,074-A). The method comprised of locating a receptive area where the function of receptors should be enhanced and applying a bias signal to this (skin) area before the informative (tactile) signals are expected to be present, perceived and identified. At that, the bias signals might have different nature such as non-specific electrical or mechanical (gas/air flow) stimulation, than informative tactile signals. Such an approach could be efficient with optimal parameters of bias signals which have to be calibrated in advance. Nevertheless, parameters of the skin vary significantly and affected by many different factors of physical, physiological (humoral), and psychological nature. Therefore, a sensitivity change will happen or not within the time interval anticipated and such a technique cannot easily be realized for occasional touch-based interaction with mobile devices.

The threshold of vibrational detection may be temporarily altered prior to the onset of a vibrotactile stimulus (e.g. U.S. Pat. No. 8,040,223-B). This allows the vibrotactile system to achieve improved detection of the vibrotactile alert or communication stimulus without necessarily increasing the vibratory displacement amplitude of the stimulus. However, such an approach does not eliminate the problems linked with signals propagation to tactile receptors for sub-sensory vibrational noise stimuli that has to change sensitivity of the skin that should actuate within the predefined time interval. Such sensitivity change will happen or not also depends on different factors of physical, physiological (humoral), and psychological nature. That is, this approach is also constrained as it is being applied for specific parameters of vibration and conditions of relatively continuous contact with the surface of interaction.

Another approach to enhance tactile perception of mechanical signals is to generate these signals directly under the fingertip in the field of contact (e.g., U.S. Pat. No. 7,375,454-B). The invention relies on excitation of surface acoustic waves on the surface of non-piezoelectric material such as glass of a touchscreen. However, increasing efficiency of mechanotransduction does not eliminate the problem of lowering tactile sensitivity when fingertip acts against a flat rigid surface such as a glass of touchscreen.

A tactile interface may include a plurality of individually controllable piezoelectric drivers positioned around a perimeter of a highly tensioned elastomeric material such as silicone rubber, polybutadiene, nitrile rubber, as well as other rubbers and elastomers (e.g., U.S. Pat. No. 8,253,703-B). Driver circuitry can apply control information to each of the plurality of individually controllable drivers to produce a wave pattern in the tensioned elastomeric material. However, there is difference of the reflective index between the elastomeric material and air. Being suspended in air, a thin elastic diaphragm will have a parallax or the surface roughness, and the images displayed on the touchscreen would get the distorted vision (e.g., JP-2005-234704-A, Fukuda T. et al. “Transparent tactile feeling device for touch-screen interface” Proc. of the 2004 IEEE Int. Workshop on Robot and Human Interactive Communication, 2004, 527-532). Suspended in air a thin elastic diaphragm can also be easily torn. On the contrast, the stiff diaphragm will produce loud sounds, often considered as a negative side effect accompanying tactile information.

### SUMMARY OF INVENTION

An aspect of the present invention provides a haptic device to be overlaid on a manipulation face for receiving a manipulation from a user. The haptic device includes a pouch, a liquid or gel-like substance and an actuator. The pouch is formed from the manipulation face and a transparent sheet overlaid thereon with a gap. The liquid or gel-like substance is sealed within the pouch and configured to transmit a pressure or/and pressure vibration therethrough. The actuator is configured to generate a haptic signal in the transparent sheet and/or the substance so as to be transmitted to the user.

According to the above-mentioned configuration, it is possible to provide the haptic device which can enhance a response of a human skin to a vibrational stimulation.

### BRIEF DESCRIPTION OF DRAWINGS

FIG. 1 is a cross-sectional view of the deformable overlay assembly covering the durable surface of the touchscreen according to an embodiment.

FIGS. 2A to 2J are cross-sectional views illustrating exemplary configurations of the deformable overlay assembly.

FIGS. 3A to 3C illustrate sectional views of various application examples of the deformable overlay assembly, FIG. 3A illustrating the case of being applied on the durable surface of the projective screen, FIG. 3B illustrating the case of being applied on the flexible and deformable surface of the reflective screen, FIG. 3C illustrating the case of being applied onto the durable surface of the touchscreen.

FIG. 4A to 4H illustrate sectional views of example arrangements of several transducers.

FIGS. 5A to 5F are plan views illustrating exemplary arrangements of the deformable transparent overlay assembly and the shear and bending wave transducers.

FIGS. 6A and 6B are cross-sectional views illustrating exemplary arrangements of the shear and bending wave transducer with respect to a portable electronic device such as a mobile phone or a like.

FIGS. 7A and 7B illustrate a casing extension for a portable electronic device according to another embodiment.

FIG. 8 illustrates a schematic diagram of the casing extension.

### DETAILED DESCRIPTION OF EMBODIMENT

The embodiments will be described with reference to the accompanying drawings. In the drawings and the description, the same reference numbers are used to refer to the same or like parts.

The embodiments will avoid the problems exhibited when fingertip acts against a flat rigid surface of the touchscreen.

In particular, a resilient and deformable overlay (e.g., polyamide film of 100 mkm) covering a layer of the liquid substance (e.g., distilled water, silicone gel, mineral oil or other material having similar mechanical and optical properties) provides necessary sinking/indentation (of about 0-3 mm) that improves a contact surface conformance to a receptive field and non-uniform distribution of forces and stresses from the contact area to skin receptors.

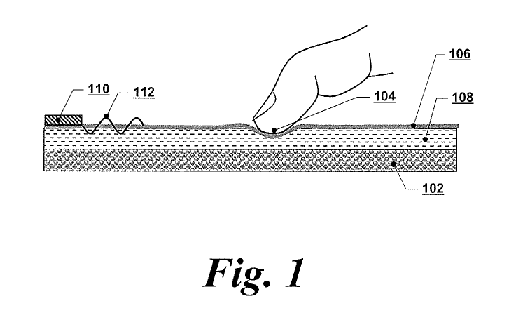

Refer to FIG. 1. As shown in FIG. 1 the compliant overlay 106 is attached to the durable surface of the touchscreen 102 with a gap filled in with a liquid or gel-like substance 108. Shear and bending waves 112 generated by transducer 110 (of piezo, electromagnetic or other nature) approach the contact point 104 with a non-uniform stress distribution between adjacently sampled points especially near the edge of indentation that facilitates the response of skin receptors to vibrotactile signals. The air-fluid transition zone will also act as attenuator/reflector of parasitic acoustic components accompanying vibration signals generated in the overlay assembly.

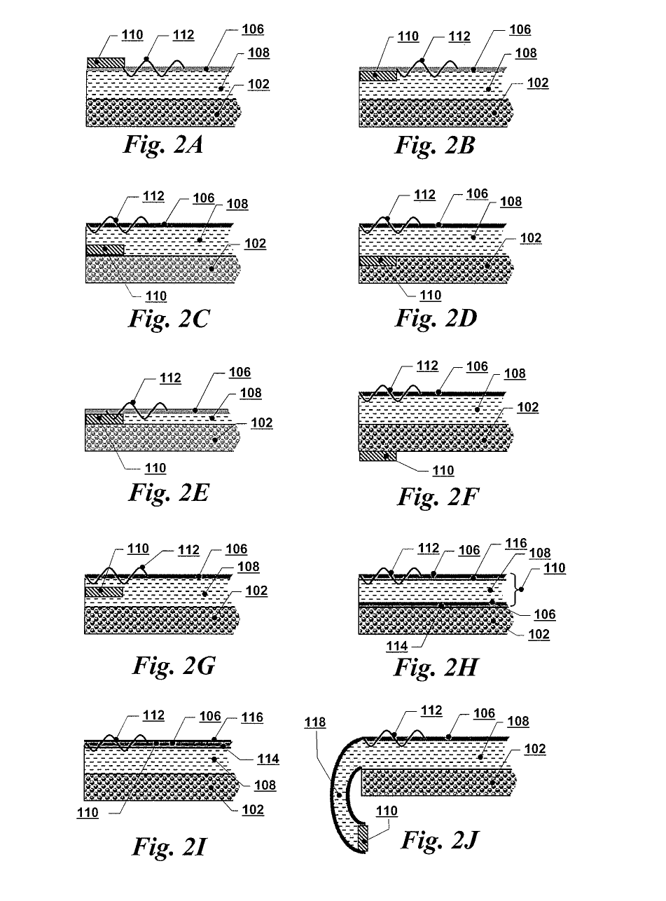

An excitation of shear and bending waves is possible to perform with different efficiency when the design of the vibration transducer 110 allows to install it not only over the compliant overlay (FIG. 2A) but also to place the transducer under the film (FIG. 2B), inside the pouch filled in with insulating liquid substance 108. The vibration transducer 110 can be installed over the durable surface of the touchscreen 102 (FIG. 2C), inside the electronic device under the touchscreen (FIG. 2F), or being embedded into the touchscreen assembly being placed closer to the outer surface (FIG. 2D). Wherein the liquid substance 108 can be in contact with the vibration transducer from one side (FIG. 2B or FIG. 2C) or can cover it from both sides as shown in FIG. 2G. In some embodiments, the vibration transducer 110 could have a limited contact with a liquid substance 108 along one side only (FIG. 2E). In such a case, an excitation of shear and bending waves can be produced with a different type of transducers (e.g., magnetostrictive or multi-layered piezo actuator, hydraulic or pneumatic, or of other nature).

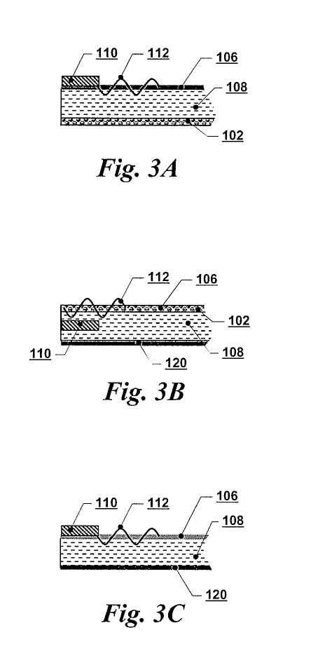

The compliant overlay assembly can also behave as a vibration transducer 110 itself (FIG. 2H). Wherein, the transducer 110 can be composed of two transparent flexible sheets 106 one-side of each is covered by a transparent and electrically conductive material illustrated as a layer 114 and 116. Alternatively, the transducer 110 can be a non-transparent material so as to be suitable for the cases as illustrated in FIGS. 3B and 3C. Two sheets are assembled into a pouch in a way that an internal conductive layer of the outer sheet has an electrical contact with a liquid substance 108, while another sheet has a conductive layer which is separated from the liquid substance 108 by insulating material of the sheet. In this embodiment the liquid substance 108 is an electrically conductive ionic liquid or gel. Such an embodiment of the transducer 110 is able to generate shear and bending waves in a wide range of frequencies as a gel-based audio speaker (e.g., Keplinger C. “Stretchable, Transparent, Ionic Conductors” Science, 2013, 341, 984-987).

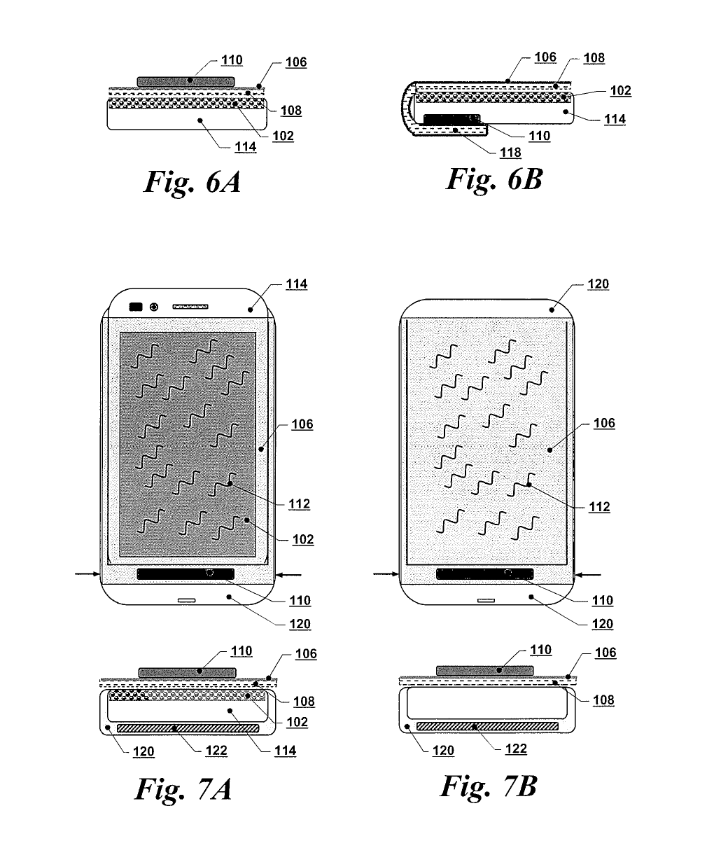

Refer to FIGS. 2A to 2J. In some embodiments, the compliant overlay 106 itself (FIG. 2G) can behave as a vibration transducer 110 producing shear and bending waves being implemented with the use of piezoelectric polymeric materials covered with transparent and electrically conductive materials illustrated as layers 114 and 116 or having embedded components thereof (e.g., Kim U. et al. “A transparent and stretchable graphene-based actuator for tactile display” Nanotechnology, 2013, 24, 145501). A vibration transducer 110 can also be placed outside of the compliant overlay assembly being mechanically coupled with an extension 118 filled in with the same gel-like or another liquid substance which is able to conduct mechanical vibrations efficiently propagated from actuator 110 to gel-like substance 108 to produce shear and bending waves 112 over the overlay surface 106. An extension 118 could be implemented from any suitable flexible polymer material with the size of normal cross-section providing minimum impedance to oscillations of the transducer, minimizing their attenuation. An extension 118 has a hermetically sealed connection to the pouch covering the touchscreen. The transducer 110 can also be coupled to the extension 118 in any way as it was illustrated in FIG. 2A-2I. Wherein, the transducer can be placed outside or inside the electronic device controlled via the touchscreen as shown in FIG. 6B.

As illustrated in FIGS. 3A to 3C, the compliant overlay 106 can be attached to the durable or flexible and deformable contact surface 120 of touch sensitive input device or the projective display screen 102 (e.g., Hilsing S. “Impress: a flexible display” Project Presentation, 2009), that is an image can be projected on a top (FIG. 3B) or bottom (FIG. 3A) surface of the overlay. In such an embodiment, the overlay should be flexible and deformable (like a silicone or foam material) transparent or non-transparent/reflective. The compliant overlay 106 can be attached to any contact surface 120 of interaction when interacting with the surface takes place in the absence of video images projected onto the contact surface (FIG. 3C). At that, the point of the fingertip contact can be detected with any suitable of known techniques (optical, thermo, piezo-acoustic and electro-magnetic). In the absence of visual feedback, special tactile patterns (e.g., Evreinov G. et al. “Information Kiosks for All: Issues of Tactile Access” Proc. of Conf WWDU 2002 World Wide Work, 2002, 399-401) can be applied to the overlay 106 to easy find the specific location under the fingertips.

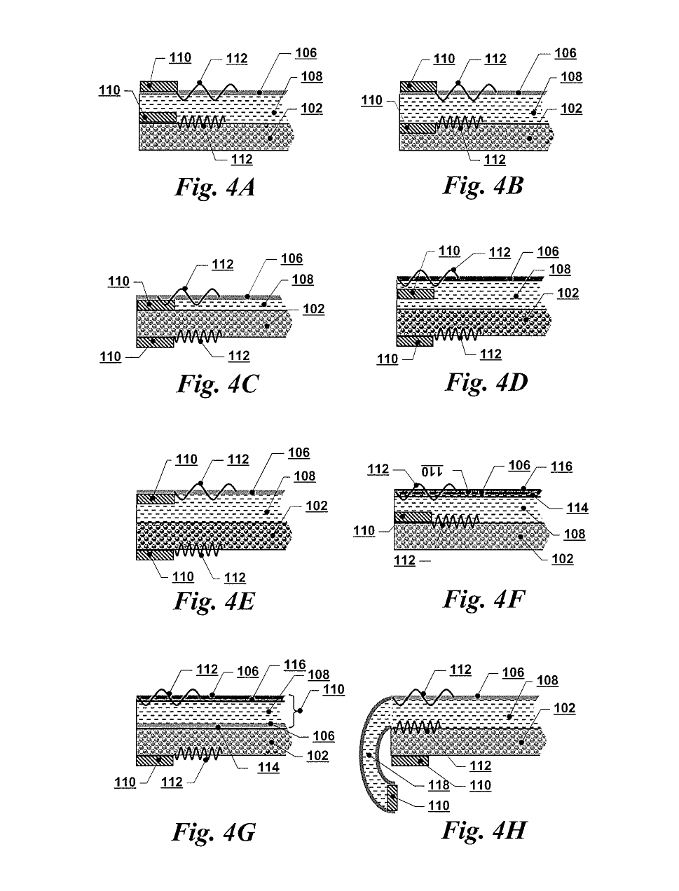

FIGS. 4A to 4H illustrate sectional views of the example arrangements of several transducers 110 capable of generating different vibration signals 112 spreading over the contact surface and across a liquid or gel-like substance 108 and the display 102 of a portable electronic device. In particular, bending waves 112 spreading over the contact surface and the second vibration signal spreading across a liquid or gel-like substance 108 and the display 102 from internal transducer 110, location of which can vary (FIGS. 4A to 4H) to produce the optimal spatial pattern of interferential vibration signals to stimulate fingertip of the user in a most efficient way, for example, by generating “pre-empting” signals (e.g. U.S. Pat. No. 8,040,223-B). However, the present invention is not limited to a specific type of overlay linked vibration transducers 110 which can use different actuation principles and technologies for generating information signals and other transducers generating pre-empting signals.

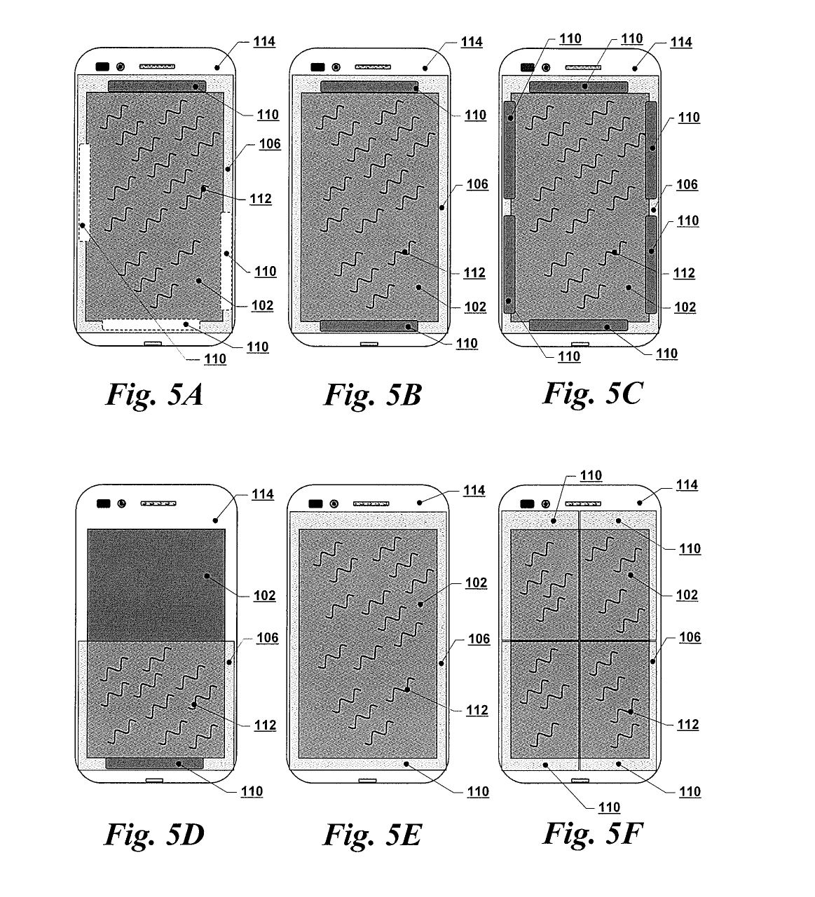

FIGS. 5A to 5F illustrate exemplary arrangements of the compliant overlay assembly and the shear and bending wave transducers. In particular, FIG. 5A shows a case when overlay is attached to a portable electronic device such as a mobile/cell phone 114 or a like and supplied with a single vibration transducer 110 which can be placed near the bezel of the touchscreen along any of four sides. FIG. 5B illustrates a case when two transducers are attached to any opposite sides of the touchscreen. This configuration can extend a functionality of vibration patterns using directional distribution of propagating energy of shear and bending waves. Similarly, an arrangements of six transducers is shown in FIG. 5C.

However, the present invention is not limited to a specific number of vibration transducers placed around, such as above or under, the contact surface of interaction. Moreover, each separate transducer or each pair of opposite transducers can be controlled independently of each other. The compliant overlay 106 can cover completely the outer surface of the touchscreen 102 of the portable device 114 as shown in FIG. 5A-5C or a segment of the whole touchscreen (FIG. 5D) completed with a suitable arrangement of the vibration transducers. The number of transducers for generating pre-empting signals from a portable electronic device and their location can also vary.

As it was illustrated in FIG. 2H and FIG. 21, the compliant overlay 106 or/and embedded actuation components generating shear and bending waves can cover the touchscreen completely (FIG. 5E) or can be split into a number of separately actuated segments (FIG. 5F). Wherein, an array of the overlay of the actuated segments can present a matrix arranged by rows and columns being controlled accordingly.

FIG. 6A illustrates a case when the compliant overlay is attached to a portable electronic device 114.

FIG. 6B illustrates another case when the vibration transducer 110 is placed inside the portable electronic device 114 and has a mechanical connection with the pouch covering the touchscreen through the extension 118.

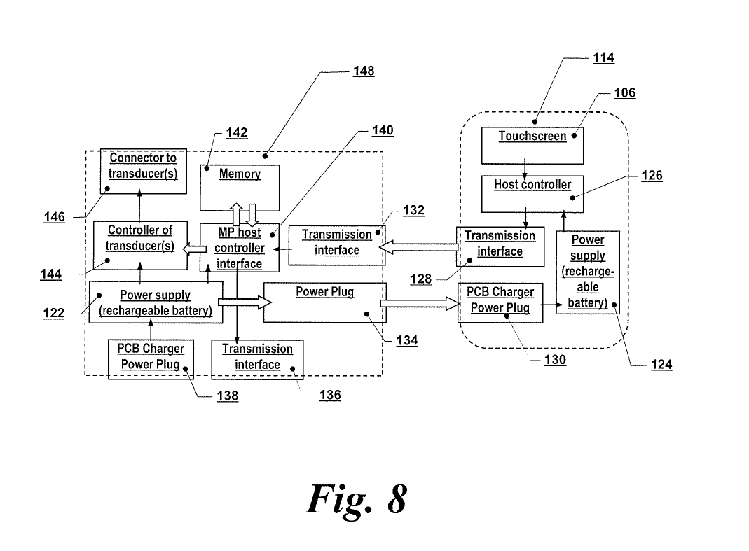

FIGS. 7A and 7B illustrate a casing extension for a portable electronic device such as a mobile/cell phone, game tablet or a like, according to another embodiment. The casing extension includes a casing 120, the compliant overlay 106, a printed circuit board 148 disposed in the casing 120, a rechargeable battery 122 disposed in the casing 120, and connectors (e.g., DC electrical male/female connectors, optical, infra-red or supporting a radio-frequency based connection) to accommodate the signals from the portable electronic device at least related but not limited to the coordinates of the contact point 104 of the fingertip position on the touchscreen, connectors with an external power source to charge the battery 122, and the connection to share energy of the battery 122 with the attached portable electronic device. The rechargeable battery 122 can be any reusable battery (e.g., a nickel-cadmium cell, a NiMH battery, a lithium cell, or a like). In more detail, the printed circuit board components are presented as a schematic diagram in FIG. 8.

As shown in FIG. 8, the printed circuit board 148 disposed in the casing 120 contains a microprocessor (MP) host controller interface 140, memory 142, controller of transducer(s) 144 and a number of connectors.

Memory 142 can include semi-permanent memory such as RAM, and/or one or more different types of memory used for storing data. Namely, memory 142 is used for storing any type of data (parameters of vibration signals, a library or database of vibrotactile effects or patterns) to operate with controller of transducer.

PCB charger power plug 130 of the portable electronic device 114 is connected to the casing extension 120 through power plug 134. The transmission interface 128 of the portable electronic device 114 is connected to the casing extension 120 through the transmission interface 132. Consequently, the signals from the MP host controller interface 140 either from the portable electronic device 114 can be further conveyed to any external device through the transmission interface 136. To charge the rechargeable battery 122, the casing extension 120 is equipped with PCB charger power plug 138. The signals from the transducer(s) controller are sent to a vibration transducer 110 through connector 146.

In addition to its main function, the battery 122 of the casing extension 120 can be used as a reserve power source of the portable electronic device 114 when the main battery 124 gets low.

While method have been described in terms of several embodiments, those of ordinary skill in the art will recognize that the design and methods are not limited to the embodiments described, but can be practiced with modification and alteration within the spirit and scope of the appended claims. The description is thus to be regarded as illustrative instead of limiting. In essence, the design is such that the screen overlay does not distort or degrades the display of the portable electronic device, in anyway.

In accordance with known lensing effect demonstrating with a skin microstructure intermediate ridges model (e.g., Gerling, G. J. “SA-I mechanoreceptor position in fingertip skin may impact sensitivity to edge stimuli” Applied Bionics and Biomechanics, 2010, 7(1), 19-29, Gerling G. J. et al. “The effect of fingertip microstructures on tactile edge perception” Eurohaptics Conference, and Symposium on Haptic Interfaces for Virtual Environment and Teleoperator Systems, 2005, 63-72), a resilient and deformable transparent overlay improves excitation and propagation of shear and bending waves to the point of contact with the durable surface of interaction. A fingertip's sink into deformable overlay's indentation provides better conditions for mechanical propagation of dynamic stress to skin receptors allowing enhancing the response of human skin to vibrotactile signals when interacting with/via an input device such as a touch-sensitive keyboard, a touchpad, a touchscreen or a like.

Deformable overlay can be implemented as a transparent pouch covering the touchscreen or a deformable outer surface of interaction separated from the touchscreen with a liquid or gel-like substance. The overlay excitation, transducer, or plurality of transducers, can be configured to induce shear and bending waves in the pouch. Due to sound absorption and distortion at the boundaries of media having different densities, such arrangement can also minimize acoustic components of vibration stimuli. The overlay may further be coupled with a case containing the detector capable of detecting the contact event and its location with respect to the contact surface, active circuits for generation vibrotactile signals, interface with a host controller and a power source.

While certain embodiments have been exemplified above, these embodiments should not limit the scope of the invention. These embodiments may be variously implemented with omissions, replacements, and/or changes and/or modifications, within the spirit and scope of the invention. For example, although the touchscreen is exemplified in the above embodiments, the present invention may be applied to any kinds of devices.

1. A haptic device to be overlaid on a manipulation face for receiving a manipulation from a user, the haptic device comprising:
a pouch formed from the manipulation face and a transparent sheet overlaid thereon with a gap;
a liquid or gel-like substance sealed within the pouch and configured to transmit a pressure or/and pressure vibration therethrough; and
an actuator configured to generate a haptic signal in the transparent sheet and/or the substance so as to be transmitted to the user.

2. A haptic device to be overlaid on a manipulation face for receiving a manipulation from a user, the haptic device comprising:
a pouch formed from a pair of transparent sheets having a gap therebetween and overlaid on the manipulation face, at least one of the transparent sheets which receives the manipulation from the user being deformable;
a liquid or gel-like substance sealed within the pouch and configured to transmit a pressure or/and pressure vibration therethrough; and
an actuator configured to generate a haptic signal in the transparent sheet and/or the substance so as to be transmitted to the user.

3. The haptic device of claim 1, further comprising:
a sensor configured to detect the pressure or/and pressure vibration generated upon the manipulation from the user onto the pouch; and
a controller configured to generate a driving signal for the actuator based on a detection result by the sensor.

4. The haptic device of claim 3,
wherein the actuator and the sensor are provided as a self-sensing transducer.

5. The haptic device of claim 1,
wherein the manipulation face is a face of a touchscreen.

6. A deformable overlay to be overlaid on a face of a durable contact surface comprising:
a flexible sheet attached to the face of the touch screen at its perimeter via an elastic double-sided adhesive tape;
a pouch formed by the flexible sheet and the face of the durable contact surface;
a substance sealed in the pouch;
an overlay-linked vibrotactile transducer configured to generate a shear and bending wave which propagates at least over a top outer surface of the flexible sheet; and
a detector configured to detect a contact event and its location with respect to the durable contact surface.

7. The deformable overlay of claim 6,
wherein the flexible sheet is formed from a transparent and elastic material.

8. The deformable overlay of claim 6,
wherein the flexible sheet is formed from a non-transparent or translucent and elastic material.

9. The deformable overlay of claim 6,
wherein the substance is a transparent liquid or gel-like substance.

10. The deformable overlay of claim 6,
wherein the substance is a natural or synthetic liquid or gel-like substance having a density similar to the density of the hypodermis of the human skin.

11. The deformable overlay of claim 6,
wherein the substance is a non-transparent elastic substance, foam material or a like having a density similar to the density of the hypodermis of the human skin.

6. The deformable overlay of claim 6,
wherein the substance is a natural or synthetic liquid or gel-like substance having a density similar to a density of a hypodermis of a human skin,
wherein the density of the hypodermis of the human skin is about 1100 kg/m³.

6. The deformable overlay of claim 6,
wherein the flexible sheet is provided in pair,
wherein one of the pair of flexible sheets is attached to the face of the durable contact surface via the elastic double-sided adhesive tape, and
wherein the pouch is formed between the pair of flexible sheets.

14. The deformable overlay of claim 13,
wherein at least the other one of the pair of the flexible sheets on a top side opposite to the durable contact surface is formed to be transparent flexible and elastic so that a shear and bending wave propagates between a point of touching by a user and a position of the overlay-linked vibrotactile transducer.

15. The deformable overlay of claim 13,
wherein both of the pair of the flexible sheets are non-transparent flexible sheets, and
wherein the substance is a non-transparent elastic substance, foam material or a like having a density similar to the density of the hypodermis of the human skin.

16. The overlay of claim 6,
wherein the overlay-linked vibrotactile transducer includes an actuator.

17. The deformable overlay of claim 16,
wherein one or more of the overlay-linked vibrotactile transducers are provided near a bezel of the durable contact surface,
wherein each of the overlay-linked vibrotactile transducers is placed onto an outer surface of the flexible sheet, onto an inner surface of the flexible sheet, or onto the face of the touch screen, and
wherein each of the overlay-linked vibrotactile transducers generates a shear and bending wave which propagates toward a point of touching by the user.

13. The deformable overlay of claim 13,
wherein the substance is an ionic gel, the bottom-side flexible sheet has an electrical contact with the substance, and the top-side flexible sheet does not have an electrical contact with the substance, thereby forming a gel-based audio speaker.

6. The deformable overlay of claim 6,
wherein the flexible sheet and the overlay-linked vibrotactile transducer are integrally implemented such that a piezoelectric polymeric material is covered with a transparent and electrically conductive layer as an electrode or such that conductors or/and piezo-actuating components are embedded.

20. The deformable overlay of claim 13,
wherein the pouch formed from the pair of flexible sheets has an extension which is provided outwardly of the durable contact surface, and
wherein the overlay-linked vibrotactile transducer is placed at the extension outside the durable contact surface.

21. The deformable overlay of claim 6,
wherein the overlay-linked vibrotactile transducer is placed on the inner surface of the flexible sheet and inside the substance.

22. The deformable overlay of claim 6,
wherein the overlay-linked vibrotactile transducer is placed on the face of the durable contact surface and inside the substance.

13. The deformable overlay of claim 13,
wherein the overlay-linked vibrotactile transducer is placed between the pair of flexible sheets and inside the substance.

24. The deformable overlay of claim 23,
wherein the overlay-linked vibrotactile transducer is sandwiched between the pair of the flexible sheets so that the overlay-linked vibrotactile transducer has a contact with the substance only at its perimeter.

25. The deformable overlay of claim 20,
wherein the overlay-linked vibrotactile transducer is placed on an inner surface of the bottom-side flexible sheet or the top-side flexible sheet, or is sandwiched between the pair of the sheets with/without a gap.

26. The deformable overlay of claim 6,
wherein the overlay is provided to cover wholly or partially the face of the durable contact surface.

27. The deformable overlay of claim 6,
wherein the overlay is provided in plurality to cover respective parts of the face of the durable contact surface.

28. The deformable overlay of claim 6,
wherein there is provided a vibrotactile transducer as a counterpart vibrotactile transducer, in addition to the overlay-linked vibrotactile transducer.

29. The deformable overlay of claim 28,
wherein the overlay-linked vibrotactile transducer and the counterpart vibrotactile transducer are configured to generate different vibration signals.

30. An attachment unit comprising:
the deformable overlay of claim 6; and
a casing provided to support the flexible sheet of the overlay.

31. The attachment unit of claim 30,
wherein the attachment unit is attached to a mobile device having the touchscreen such that the flexible sheet directly touches or indirectly faces with the touchscreen.

32. The attachment unit of claim 30,
wherein the attachment unit is attached to a portable electronic device.

33. The attachment unit of claim 32, further comprising:
a printed circuit board;
a rechargeable battery;
an external power supply connector configured to receive a DC external power;
an internal power supply connector configured to supply an electrical power stored in the rechargeable battery with the attached portable electronic device; and
an information exchange connector configured to exchange information with the portable electronic device and another device, the information including a coordinate of the point of touching by the user on the touchscreen or a modulated parameter for a vibration signal.

34. The attachment unit of claim 30,
wherein the rechargeable battery is a nickel-cadmium cell, a NiMH battery, or a lithium cell.

35. The attachment unit of claim 34,
wherein the electrical power stored in the rechargeable battery is supplied to the portable electronic device when a remaining amount of a main battery thereof becomes low.

36. The attachment unit of claim 33,
wherein the printed circuit board includes a microprocessor host controller interface, a memory, and a transducer controller,
wherein the transducer controller controls not only the overlay-linked vibrotactile transducer but also the counterpart transducer.

37. The attachment unit of claim 36,
wherein the memory is a non-volatile memory.

38. The haptic device of claim 1,
wherein the manipulation face is configured to receive a pressure manipulation from the user.

39. The haptic device of claim 2,
wherein the manipulation face is configured to receive a pressure manipulation from the user.
